(19) United States
(12) Patent Application Publication
(10) Pub. No.: US 2012/0307889 A1
(43) Pub. Date: Dec. 6, 2012

(54) VIDEO DECODER WITH DYNAMIC RANGE ADJUSTMENTS

(75) Inventors: Louis Joseph Kerofsky, Camas, WA (US); Kiran Misra, Vancouver, WA (US); Christopher A. Segall, Camas, WA (US)

(73) Assignee: SHARP LABORATORIES OF AMERICA, INC., Camas, WA (US)

(21) Appl. No.: 13/150,541

(22) Filed: Jun. 1, 2011

(51) Int. Cl. H04N 7/26

(52) U.S. Cl. 375/240.03; 375/E07.027

(57) ABSTRACT

A system for decoding video including receiving quantized coefficients representative of a block of video representative of a plurality of pixels and dequantizing the quantized coefficients. Inverse transforming the dequantized coefficients to determine a decoded residue wherein the dequantized coefficients are modified prior to the inverse transforming based upon a predicted dynamic range output of the inverse transform.

### CROSS-REFERENCE TO RELATED APPLICATIONS

None.

### BACKGROUND OF THE INVENTION

The present invention relates to image decoding with dynamic range adjustments.

Existing video coding standards, such as H.264/AVC, generally provide relatively high coding efficiency at the expense of increased computational complexity. As the computational complexity increases, the encoding and/or decoding speeds tend to decrease. Also, the desire for increased higher fidelity tends to increase over time which tends to require increasingly larger memory requirements and increasingly larger memory bandwidth requirements. The increasing memory requirements and the increasing memory bandwidth requirements tends to result in increasingly more expensive and computationally complex circuitry, especially in the case of embedded systems.

Referring to FIG. 1, many decoders (and encoders) receive (and encoders provide) encoded data for blocks of an image. Typically, the image is divided into blocks and each of the blocks is encoded in some manner, such as using a discrete cosine transform (DCT), and provided to the decoder. The decoder receives the encoded blocks and decodes each of the blocks in some manner, such as using an inverse discrete cosine transform. In many cases, the decoding of the image coefficients of the image block is accomplished by matrix multiplication. The matrix multiplication may be performed for a horizontal direction and the matrix multiplication may be performed for a vertical direction. By way of example, for 8-bit values, the first multiplication can result in 16-bit values, and the second multiplication can result in 24-bit values in some cases. In addition, the encoding of each block of the image is typically quantized, which maps the values of the encoding to a smaller set of quantized coefficients used for transmission. Quantization requires de-quantization by the decoder, which maps the set of quantized coefficients used for transmission to approximate encoding values. The number of desirable bits for de-quantized data is a design parameter. The potential for large values resulting from the matrix multiplication and the de-quantization operation is problematic for resource constrained systems, especially embedded systems.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates an encoder and a decoder.

FIG. 2 illustrates a decoder with a dequantizer and an inverse transform.

FIGS. 3A and 3B illustrate a dequantizer.

FIGS. 4A-4E illustrate inverse transforms.

FIG. 5 illustrates another decoder.

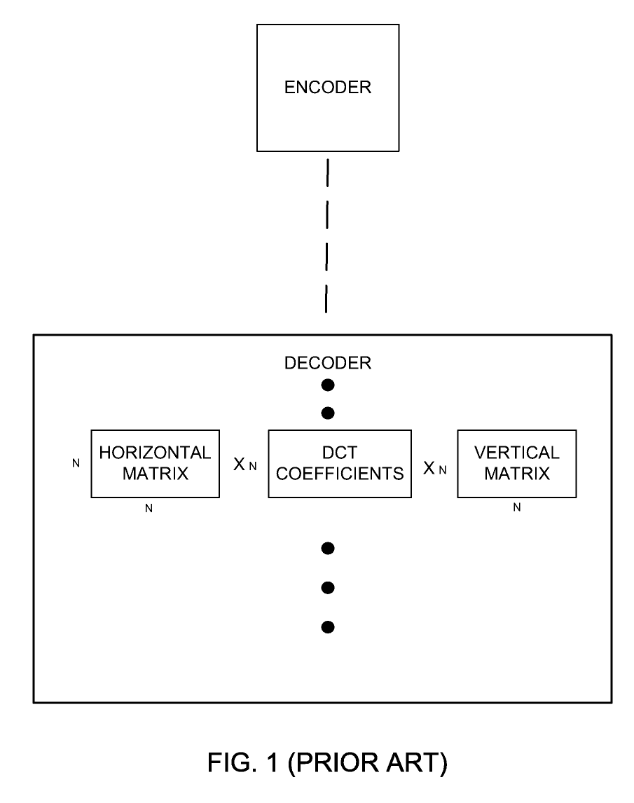

### DETAILED DESCRIPTION OF PREFERRED EMBODIMENT

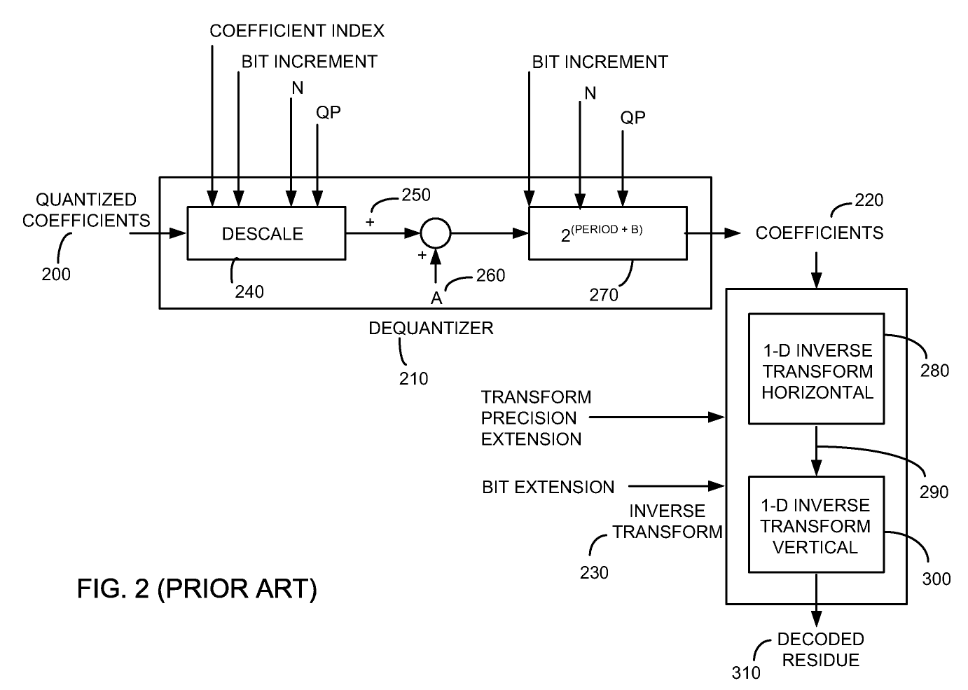

Referring to FIG. 2 (prior art), a decoder for the dequantization and inverse transformation of the received quantized coefficients from the encoder for a block of the image is illustrated, in relevant part. The decoder receives the quantized coefficients 200 at a dequantizer 210. The coefficients resulting from the dequantizer 210 are stored in memory 220. The coefficients stored in memory 220 are then processed by a pair of inverse transforms 230 to determine a decoded residue 310. The inverse transform maps data from a transform domain to a spatial domain using a matrix multiplication operator.

The dequantizer 210 includes a descaling process 240. The descaling process 240 descales the quantized coefficients 200. The descaling process corresponds to multiplying level values (also referred to as quantized coefficients 200) with one integer number dependent on quantization parameter, coefficient index, and transform size. An example of the descaling process 240 may include Level*IntegerValue(Remainder,coefficient index)*16 for a dequantizer used prior to an 8×8 inverse transform and Level*IntegerValue (Remainder, coefficient index) for a dequantizer used prior to other transform sizes. The descaling process 240 is preferably based upon a function of a remainder, transform size, and/or a coefficient index (e.g., position), to determine an intermediate set of values 250. The remainder is the sum of the quantization parameter (QP)+P*BitIncrement modulo P ((QP+P*Bitlncrement) % P). Modulo as defined in the H.264/AVC standard is defined as: x % y, as remainder of x divided by y, defined only for integers x and y with x>=0 and y>0. In one embodiment P may take on the value 6. An adjustment mechanism A 260 may be applied to the values 250, which may be a variable dependent on transform size and/or a function of a received Period. The period is the sum of the quantization parameter (QP)+P*BitIncrement divided by P ((QP+P*BitIncrement)/P), where “BitIncrement” is the bit depth increment. The “/” as defined in the H.264/AVC standard is defined as: integer division with truncation of the result towards zero. For example, 7/4 and −7/−4 are truncated to 1 and −7/4 and 7/−4 are truncated to −1. In one embodiment P may take on the value 6. The resulting values 250, possibly further modified by mechanism A 260, may be further modified by a factor of 2^{(Period+B)} 270. B is a variable that is dependent on the transform size. The results of the modification 270 are stored in the memory 220. The inverse transformation 230 may perform a 1-dimensional inverse horizontal transform 280, which is stored in memory 290. The inverse transform 230 may also perform a 1-dimensional inverse vertical transform 300, which results in the decoded residue 310. The transforms 280 and 300 may be swapped with each other, as desired.

The magnitude of intermediate values of the video decoder illustrated in FIG. 2, when implemented within the “Part 10: Advanced Video Coding”, ISO publication: ISO/IEC 14496-10:2005—Information Technology—Coding Of Audio-Visual Objects (incorporated by reference herein) (H.264/AVC standard), may be limited by using a constraint. For example, in section 8.5.10 of the H.264/AVC standard, the width of the memory access for 4×4 luma DC transform coefficients is limited by including the following statements: “The bitstream shall not contain data that result in any element fᵢⱼ of f with i,j=0.3 that exceeds the range of integer values from −2^{(7+bitDepth)} to 2^{(7+bitDepth)}−1, inclusive.” and “The bitstream shall not contain data that result in any element dcYᵢⱼ of dcY with i,j=0.3 that exceeds the range of integer values from −2^{(7+bitDepth)} to 2^{(7+bitDepth)}−1, inclusive.” The H.264/AVC standard includes similar memory limitation for other residual blocks. In addition to including a complex memory bandwidth limitation, the H.264/AVC standard includes no mechanism to ensure that this limitation is enforced. Similarly, the JCT-VC, “Draft Test Model Under Consideration”, JCTVC-A205, JCT-VC Meeting, Dresden, April 2010 (JCT-VC), incorporated by reference herein, likewise does not include a memory bandwidth enforcement mechanism. For robustness, a decoder must be prepared to accept bitstreams which may violate these limits as may be caused by transmission errors damaging a compliant bitstream or a non-conforming encoder. To alleviate such potential limitations the decoder frequently includes overprovisioning of the bit-depth of operations, at added expense and complexity in terms of memory bandwidth and storage requirements, to accommodate the non-compliant bit streams that are provided.

In order to provide a more computationally robust decoder with limited memory bandwidth and/or memory storage requirements while maintaining a high dynamic range, the decoder should be modified in a suitable manner. However, while modifying the decoder to reduce the memory requirements while maintaining a high dynamic range, the corresponding rate distortion performance of the video should not be substantially degraded. Otherwise, while the computational requirements may be reduced, the resulting quality of the video will not be suitable for viewing by the audience. The modification 270 results in a doubling of the coefficient value for every 6 steps in the quantization parameter, and thus may substantially increase the size of the memory requirements. The increased value results in one or more zeros being included as the least significant bits.

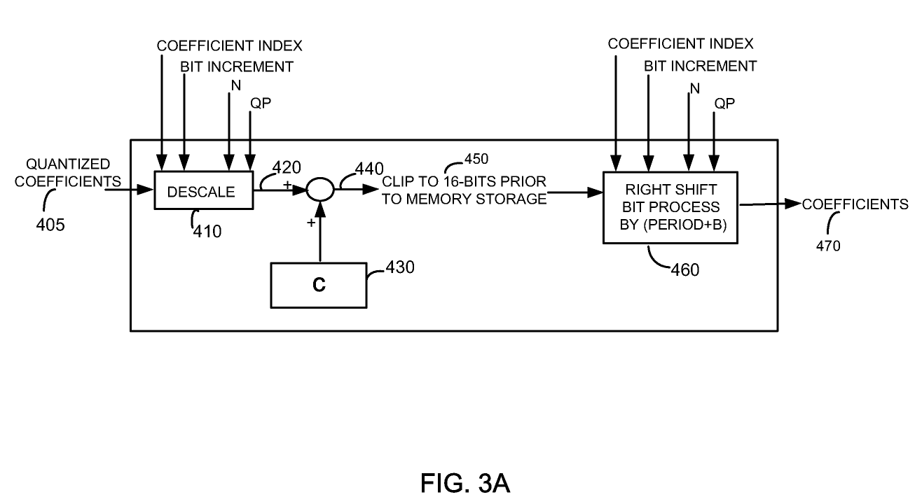

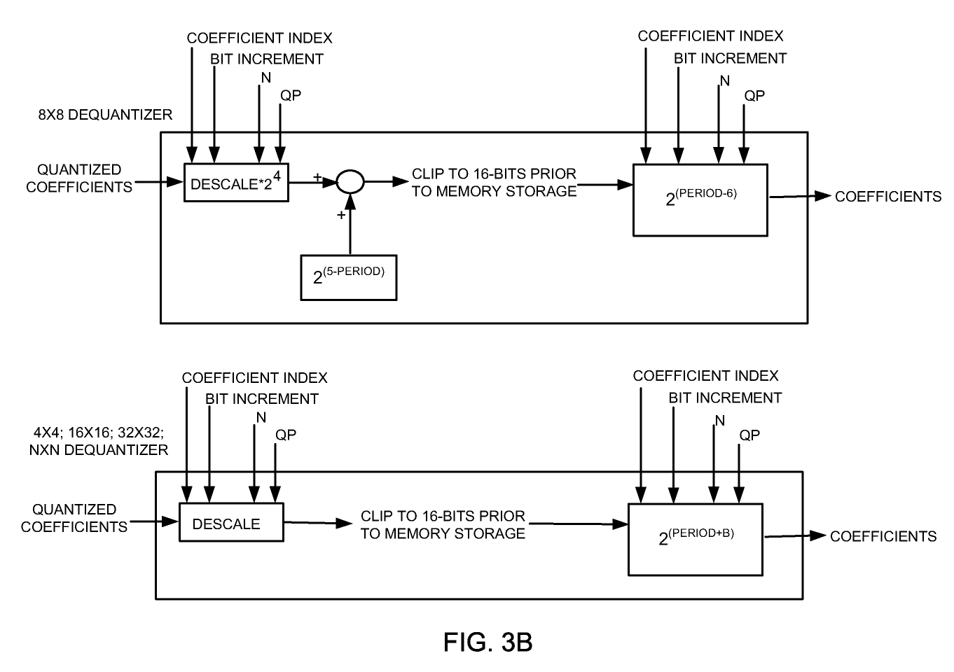

Referring to FIG. 3A, with this understanding of the operation of the dequantizer 210 (see FIG. 2, prior art) an improved dequantizer 400 (see FIGS. 3A and 3B) receives the quantized coefficients 405 and descales 410 the quantized coefficients, preferably based upon a function of a remainder, transform size, and/or a coefficient index (e.g., position), to determine an intermediate set of values 420. An optional adjustment mechanism C 430 may be applied, which is preferably a variable dependent on transform size (N) or a function of a received quantization parameter (QP), to determine resulting data 440. The resulting data 440 from the quantized coefficients 405 may include rogue data or otherwise is not compliant with a standard, and accordingly the modified dequantizer 400 should impose a fixed limit on the resulting data 440. The resulting data 440 is preferably clipped 450 to a predetermined bit depth, and thus an N×N block of data is stored in memory within the dequantizer 400. For example the clipping 450 for a predetermined bit depth of 16 bits results in any values over 32,767 being set to the maximum value, namely, 32,767. Likewise for a predetermined bit depth of 16 bits results in any values less than −32,768 being set to the minimum value, namely, −32,768. Other bit depths and clipping values may likewise be used. In this manner, the maximum memory bandwidth required is limited by the system, in a manner independent of the input quantized coefficients. This reduces the computational complexity of the system and reduces the memory requirements, which is especially suitable for embedded systems.

After imposing the clipping 450, the data with the maximum predetermined bit depth is modified by a factor of 2^{(Periiod+B)} 460. The results of the modification 460 are provided as coefficients 470. The result of performing the 2^{(Period+B)} 460 after the clipping 450 reduces the rate distortion loss. Preferably, the adjustment mechanism C 430 used for 8×8 transform coefficients is 2^{(5-Period)} and the 2^{(Period+B)} 460 is 2^{(Period-6)}. The process 460 may be based upon, if desired, a function of the transform size (N) or a function of a received quantization parameter (QP). Also, the adjustment mechanism C 430 used for other sized transform coefficients (such as 4×4, 16×16, and 32×32) is preferably zero, and the valued of 2^{(Period+B)} 460 is 2^{(Period)}. Also, B may be a function of N and C may be a function of N. Referring to FIG. 3B, a particular implementation of FIG. 3A is illustrated. It is to be understood that any suitable dequantizer may be used.

It is to be understood that any suitable dequantizer may be used. For example, the clipping to 16 bits (or any other suitable bit depth such as for example 14 bits) may be performed as the last step of the dequantizer. Moreover, preferably the bit depth of the coefficients 470 are predetermined to a known bit depth. Also, the dequantization may include a “final” shifting operation to achieve the predetermined known bit depth for the coefficients 470.

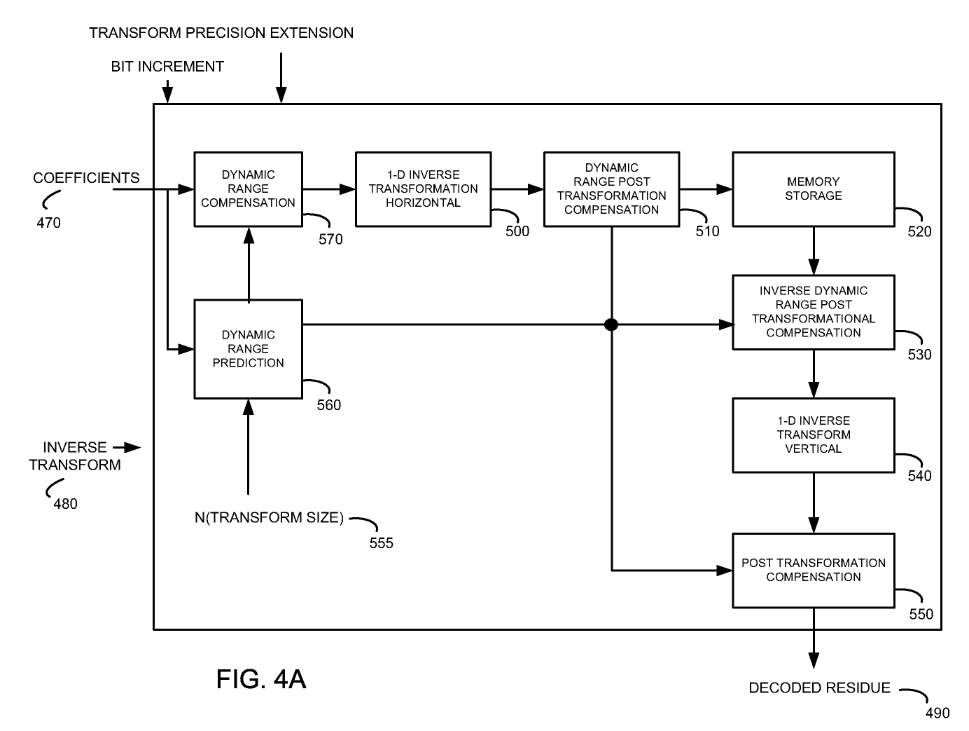

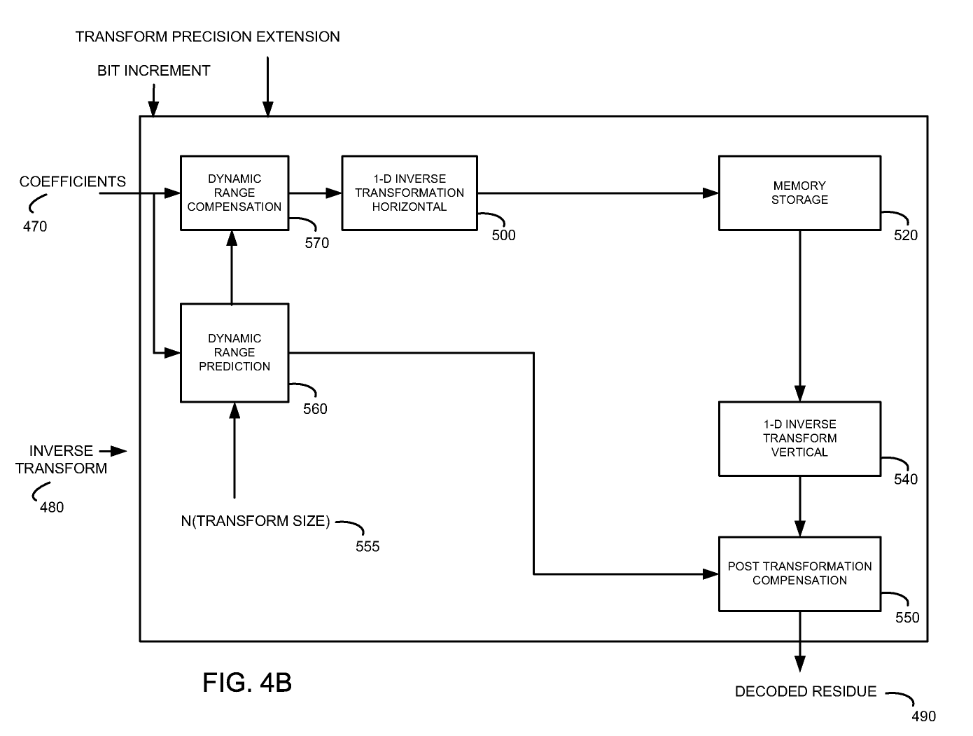

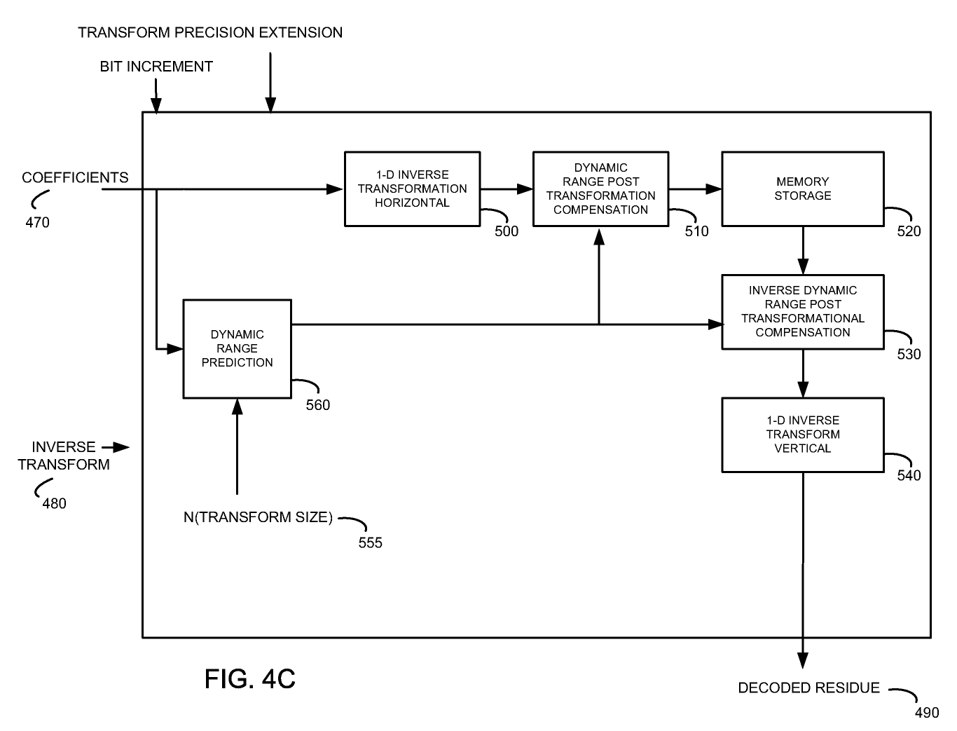

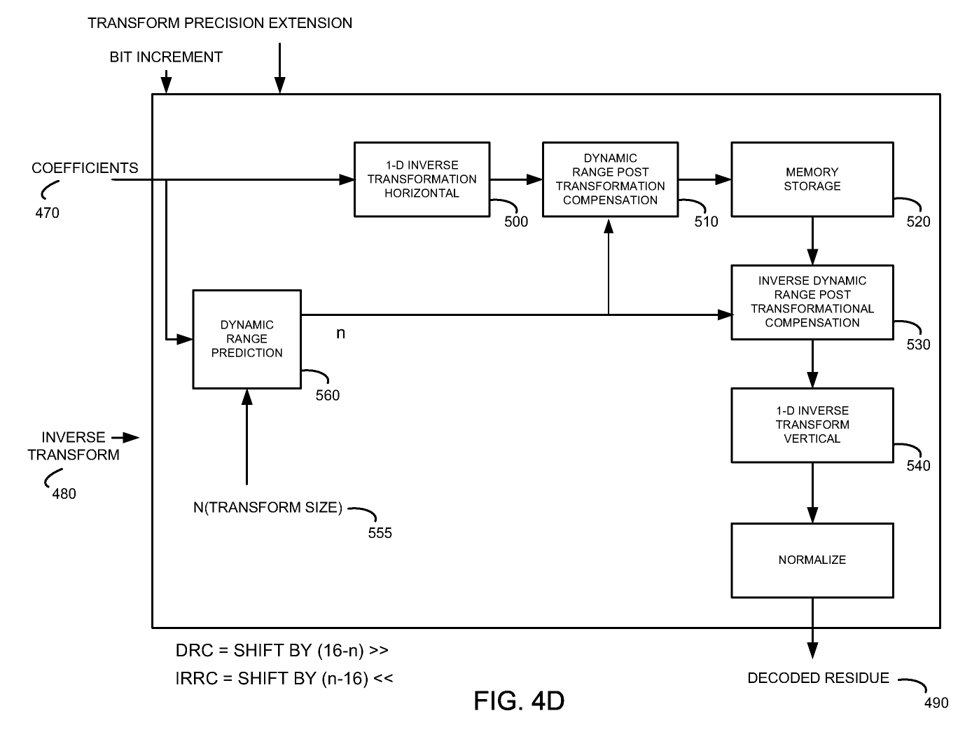

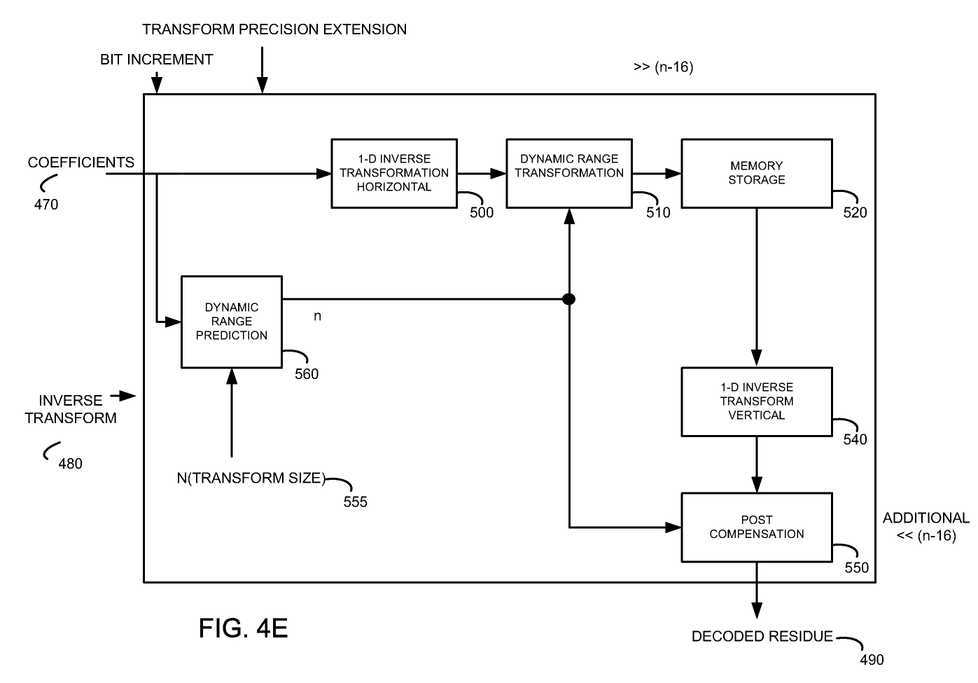

Referring to FIG. 4A, the coefficients 470 from the dequantizer 400 (see FIGS. 3A and 3B) are provided to an inverse transform 480 designed to provide a decoded residue 490 that has an acceptable rate distortion loss. The coefficients 470 are preferably transformed by a 1-dimensional inverse horizontal (or vertical) transform 500. The resulting dynamic range from the 1-dimensional inverse transform 500 may be estimated by a dynamic range prediction 560, and in many cases, the dynamic range prediction 560 indicates that the resulting dynamic range from the particular coefficient 470 would be greater than the desired dynamic range. Data from the dynamic range prediction 560 may be provided to a dynamic range compensation 570 which modifies the coefficients 470 in a suitable manner such that the output of the 1-dimensional inverse transform 500 is within the desired dynamic range. The modification may be based upon any suitable technique, such as for example, a shifting process, a scaling process, a clipping process, and/or a zeroing process (described in greater detail later). Accordingly by using a pre-compensation technique for the coefficients, the dynamic range of the output of the inverse transform may be suitably controlled in a manner consistent with maintaining sufficient image quality. This technique may be implemented in a manner that guarantees or otherwise enforces the dynamic range at the output of the first 1-D inverse transform 500.

It is to be understood that the first 1-D inverse transform may be horizontal and/or vertical. In addition, the inverse transform may use any suitable technique, including for example, a two-dimensional transform implement as a sequence of a pair of one dimensional transforms.

In many cases, the dynamic range compensation 570 may result in a rather aggressive modification to the coefficients 470 beyond that desirable to maintain a suitably high image quality. In this case, the dynamic range compensation 570 may be used in conjunction with a dynamic range post transformation compensation 510 which may further modify the resulting data to a desired dynamic range, such as 16 bits. The dynamic range prediction 560 may provide data to the dynamic range post transformation compensation 510 indicating a suitable post transformation modification. The post transformation may be any suitable technique, such as for example, a shift process. Accordingly, using a pre-compensation technique 570 for the coefficients together with a post-compensation technique 510 for the coefficients, the inverse transform may be performed in a manner consistent with maintaining sufficient image quality. The resulting data from the dynamic range post transformation compensation 510 having a suitable dynamic range, such as 16 bits, is stored in a memory storage 520.

In some cases, the dynamic range post transformation compensation 510 is suitable to be reversed, at least to some extent. For example, if the dynamic range post transformation compensation 510 shifts the bits two to the right, an inverse dynamic range post transformation compensation 530 may be used to reverse (or generally reverse) the process, such as shifting the bits two to the left. A 1-dimensional inverse vertical (or horizontal) transform 540 may operate on the data from the inverse dynamic range post transformation compensation 530 and the memory storage 520 (see FIG. 4A and FIG. 4C), or may operate on the data from the 1-D inverse transformation horizontal 500 and the memory storage 520 (see FIG. 4B). Since the data from 1-dimensional inverse vertical transform 540 is not typically stored in memory, it may not be as meaningful to provide controls on the dynamic range of its output and thus there may be no need for another dynamic range compensation for the 1-dimensional inverse vertical transformation 540. If desired, the dynamic range prediction 560 may take into account the 1-dimensional inverse horizontal transform 500 and the 1-dimensional inverse vertical transformation 540.

The modified effects of the 1-dimensional inverse vertical transform 540 is the result of primarily the modifications from the dynamic range compensation 570, since the dynamic range post transformation compensation 510 and the inverse dynamic range post transformation compensation 530 tend to have offsetting effects. In some embodiments, the compensations 510 and 530 may be omitted, or the compensations 510 and 530 may permit unity compensations so the data remains unchanged. The resulting data from the 1-dimensional inverse vertical transform 540 may be modified by a post transformation compensation 550. The post transformation compensation 550 preferably reverses (or substantially reverses) the dynamic range compensation 570. For example, if the dynamic range compensation 570 was shift right by 3 bits, then the post transformation compensation 550 is preferably shift left by 3 bits. In many cases the dynamic range prediction 560, is based upon the transformation size (N) 555. The transformation size (N) is typically related to different inverse transforms being used.

One way to characterize the dynamic range prediction 560 is as follows:

If Norm Coefficients >= TH(First1d inv. trans.) then

Dynamic Range Violation = true

ELSE

Dynamic Range Violation = false

ENDIF

For Example, the predicted dynamic range process described herein may be used to construct the value sent from the dynamic range prediction 560 to the other modules (dynamic range compensation 570, dynamic range post transformation compensation 510, inverse dynamic range post transformational compensation 530, and post transformation compensation 550). Each of these modules may use the predicted dynamic range to control its processing. Equivalently, a single control value may be provided by the dynamic range prediction 560 to control the compensation processes. For example, the dynamic range prediction 560 may be used to control a set of shifts used in the compensation modules based on the difference between the predicted dynamic range and desired intermediate dynamic range used in the memory storage i.e. 16-bits.

Where (1) Norm is some measure of the coefficients, such as a L1 norm of row, L1 norm of column, L1 norm of block, L-infinity norm of row, L-infinity norm of column, L-infinity norm of block, a maximum function, a minimum function, etc.; (2) TH is a threshold, such as L-infinity norm of row/column/block of transformation matrix plus a size dependent error term multiplied by a scalar value dependent on the dynamic range post transformation compensation or L−1 norm of row/column/block of transformation matrix plus a size dependent error term multiplied by a scalar value dependent on the dynamic range post transformation compensation; (3) First1d inv. trans. is a transformation matrix which often varies with the transformation size N; and (4) Dynamic Range Violation indicates that the coefficients should be modified by the dynamic range compensation. The L1 norm of a row, a column, or a block is the sum of absolute value of entries of the row, the column, or the block, respectively. The L-infinity norm of a row, column, or block is the maximum absolute value of the entries in the row, column, or block respectively. For example, the norm may be the maximum over the rows of the L1-norms of the columns of a block.

As illustrated, rather than using a binary decision of in range or out of range, a prediction of dynamic range may be provided that is used to provide additional control over the compensation processes. Given the coefficients, the system may compute the norm (different options), which is used to predict intermediate dynamic range from norm and transform properties. The norm may be as defined in JCTVC-E333, incorporated by reference herein. This predicted dynamic range may be used in the dynamic range compensation (570), the dynamic range post transformation compensation (510) and the inverse dynamic range post transformational compensation (530).

One example of the dynamic range prediction is based on the coefficient norm and transform analysis. The intermediate dynamic range is the term ∥M·\vec{x}∥_{∞} which is predicted from (bounded by) either the product of L1-norm of the transform matrix and the L infinity norm of the coefficient vector or predicted from the product of the L infinity norm of the transform matrix and the L1-norm of the coefficient vector.

Predicted Dynamic Range=∥M·\vec{x}∥_{∞}≦∥M∥₁·∥\vec{x}∥_{∞} Eq 1

Predicted Dynamic Range=∥M·\vec{x}∥_{∞}≦∥M∥_{∞}·∥\vec{x}∥₁ Eq 2

The transform norm then depends upon analysis of the transform and varies based upon block size.

The dynamic range compensation (DRC) 570 and post transformation compensation (PTC) 550 may include any suitable technique. For example, the dynamic range compensation 570 may include scaling, bit-shift, and/or zero-out. The scaling may be for example, DRC(x)=x/Scale1(x,N), then PTC=x*Scale2(x,N), where x is the input data, Scale1 is a variable, Scale2 is a variable, and N is the matrix transform size. Also, the DRC(x) and PTC(x) may further include rounding. The bit shift may be for example, DRC(x)=(x+offset(ShiftDRC(x,N)))>>ShiftDRC(x,N), then PTC(x)=x<<ShiftDRC(x,N). The zero-out may be for example, DRC(x)=zero-out a subset of coefficients so that Norm Coefficients <TH(First 1D inv. trans.), then PTC(x)=x. Relatively, the bit-shift and zero-out embodiments of DRC(x) have lower computational complexity compared to scaling.

Referring to FIG. 4B, a modified technique is shown where the coefficients 470 from the dequantizer 400 are provided to an inverse transform 480 designed to provide a decoded residue 490 that has an acceptable rate distortion loss. In the embodiment illustrated in FIG. 4B, the dynamic range post transformation compensation are omitted.

Referring to FIG. 4C, another technique is shown where the coefficients 470 from the dequantizer 400 are provided to an inverse transform 480 designed to provide a decoded residue 490 that has an acceptable rate distortion loss. In the embodiment illustrated in FIG. 4C, the dynamic range compensations are omitted.

Referring to FIG. 4D and FIG. 4E, the Scale1(x,N), Scale2(x,N), and shiftDRC(x,N) may be derived from the predicted dynamic range and preferably have intermediates values below 16-bits. If the predicted dynamic range is n and the desired intermediate dynamic range is 16-bits, then the dynamic range post transformation compensation 510 may right shift by n−16 bits and inverse dynamic range post transformational compensation 530 may left shift by the same amount n−16 bits. The system may shift some of the dynamic range compensation 510 to the dynamic range compensation 570, and shift some of the inverse dynamic range post transformational compensation 530 to the to post transform compensation 550.

Alternatively the prediction and compensation aspects of FIG. 4A can be data independent by controlling the bit-depth at the output of the dequantizer (470). In some embodiments the size of the resulting clipping operations may be dependent on the size of the blocks. Thus, for smaller block sizes the clipping may result in a smaller bit depth.

Given a vector of coefficient values, and a desired limit on the L1-norm, the zero-out process may modify selected coefficients to reduce the L1-norm of the coefficient vector. The modified coefficients may be reduced in absolute value or set to zero reducing the sum of absolute values of the coefficient vector and hence the L1-norm. By way of example, consider the length 8 vector v={22,−10,0,5,16,−9,8,−7}. This vector has L1-norm 77=22+10+0+5+16+9+8+7. If a threshold of 63 were given for the L1-norm, the result of zeroing out values could be vz={22,−10,0,5,16,−9,1,0} which has L1-norm 63=22+10+0+5+16+9+1=0. Note the coefficients near the end were reduced in absolute value toward zero until the L1-norm limit was met. In this case, the last coefficient with value −7 was reduced in absolute value to 0 an the second to the last coefficient with value 8 was reduced in absolute value until the L1-norm limit was satisfied.

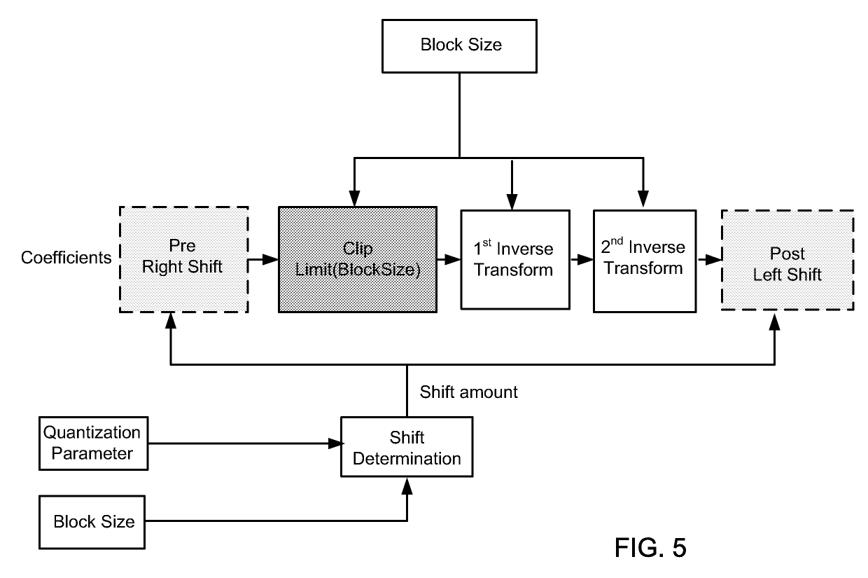

Referring to FIG. 5, another embodiment includes a block size parameter which may be used as an input for block size dependent pre-clipping of the coefficients to further permit control over the dynamic range. Also, the block size parameter may be used as an input for one or more of the inverse transforms. Moreover, the quantization parameter may be used as an input to the shift determination function. Further, the block size parameter may be used as an input to the shift determination, which determines a shift amount, which may be used for a pre-right shift and/or a post left-shift. For example, the clipping may be reduces as the block size is increased. For example, the clipping limits may decrease by 1 bit for each doubling of the transform block size. The same parameter relating to the block size or different block size related parameters for one or more of the different functions, may be used.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for decoding video comprising:
(a) receiving quantized coefficients representative of a block of video representative of a plurality of pixels;
(b) dequantizing said quantized coefficients;
(c) inverse transforming said dequantized coefficients to determine a decoded residue;
(d) wherein said dequantized coefficients are modified prior to said inverse transforming based upon a predicted dynamic range output of said inverse transform.

2. The method of claim 1 wherein said predicted dynamic range output is based upon a transform size.

3. The method of claim 1 wherein said predicted dynamic range output is based upon said dequantized coefficients.

4. The method of claim 1 wherein said modified dequantized coefficients result in a predetermined dynamic range output from said inverse transforming.

5. The method of claim 1 wherein said modification is a shifting process.

6. The method of claim 1 wherein said modification is a clipping process.

7. The method of claim 1 wherein said modification is a zeroing process.

8. The method of claim 1 further including another modification after said inverse transforming prior to storing said inverse transformed dequantized coefficients in a memory storage.

9. The method of claim 8 wherein said another modification together with said modified dequantized coefficients result in a predetermined dynamic range prior to storing the resulting data in said memory storage.

10. The method of claim 9 further comprising a further modification after reading said resulting data from said memory storage that substantially reverses said another modification.

11. The method of claim 10 further comprising inverse transforming said further modified data.

12. The method of claim 9 wherein said another modification is based upon a transform size.

13. The method of claim 10 wherein said further modification is based upon a transform size.

14. The method of claim 11 further comprising a post transformation compensation that substantially reverses said modification of said quantized coefficients.

15. The method of claim 1 wherein said modification is based upon block size.

16. The method of claim 1 wherein said inverse transforming is based upon block size.

17. The method of claim 1 wherein said modification is a shifting process based upon block size.

18. The method of claim 1 wherein said modification is a shifting process based upon a quantization parameter.
